(19) United States
(12) Patent Application Publication
(10) Pub. No.: US 2021/0237302 A1
(43) Pub. Date: Aug. 5, 2021

(54) FOOD SLICER

(71) Applicant: CFS Brands, LLC, Oklahoma City, OK (US)

(72) Inventors: Leslie A. Rhodes, Norman, OK (US); Phonvilay Sengvilay, Edmond, OK (US); Cory Benjamin Jones, Nichols Hills, OK (US)

(21) Appl. No.: 16/781,085

(22) Filed: Feb. 4, 2020

(51) Int. Cl. B26D 7/26; B26D 1/30; B26D 5/10

(52) U.S. Cl. CPC B26D 7/2614; B26D 2210/02; B26D 5/10; B26D 1/30

(57) ABSTRACT

A food slicer has a base with a plurality of spaced apart primary food support members extending upwardly therefrom and a complementary food support removably connected to the base. The complementary food support has a plurality of spaced apart complementary food support members and the primary and complementary food support members define a plurality of substantially equal width cutting spaces therebetween. A cutter has a plurality of spaced apart cutter blades configured to pass through the cutting spaces and a food product supported on the primary and complementary food support members.

There are a number of food slicers that are used to slice food products in a variety of shapes and sizes. Food slicers used in a commercial environment generally are of a type that must be washed in commercial washing equipment and as a result are not NSF rated.

### BRIEF DESCRIPTION OF THE DRAWINGS

FIG. 1 is a perspective view of the food slicer in an open position.

FIG. 2 is a side view of the food slicer in an open position.

FIG. 3 is a side view of the food slicer in a closed position.

FIG. 4 is a top view of the base of the food slicer.

FIG. 5 is a side view of the base of the food slicer.

FIG. 6 is a perspective view of the base of the food slicer.

FIG. 7 is a perspective view of the complementary food support of the food slicer.

FIG. 8 is a top view of the complementary food support of the food slicer.

FIG. 9 is a top view of the complementary food support of the food slicer attached to the base of the food slicer.

FIG. 10 is a perspective view of the cutter of the food slicer.

FIG. 11 is a top view of the cutter of the food slicer.

FIG. 12 is a section from line 13-13 of FIG. 11.

FIG. 13 is a top view of the food slicer in the closed position.

### DESCRIPTION OF AN EMBODIMENT

Referring now to the figures, a food slicer 10 comprises a base 15, a complementary food support structure 20 and a cutter 25. Both of complementary food support structure 20 and cutter 25 are detachably reconnectable to base 15. In other words each of the cutter 25 and food support 20 may be detached from the base 15 in a non-destructible matter and may be reconnected for operation. This results in an “easily cleanable” food slicer. Easily cleanable as used herein means easily cleanable as defined in NSF/ANSI 170 and is defined as “manufactured so that food and other soiling material may be removed by manual cleaning methods.” NSF/ANSI 170-2015, pg. 5.

The term manual cleaning is defined in NSF/ANSI 170 as “cleaning by hand with appropriate cleaning tools.” NSF/ANSI 170-2015, pg. 9. The key words in the definition of manual cleaning are “cleaning by hand.” The use of a dishwasher or other type of pressure spraying devices are thus excluded. A cloth, sponge, or a brush is an appropriate cleaning tool under the definition. In order for an item to be considered easily cleanable it must also comply with all of the design, construction and material smoothness requirements that are applicable to the zone of intended use. The slicer 10 described herein is easily cleanable in that it meets the criteria for being considered easily cleanable as described herein. Each of base 15, complementary food support 20 and cutter 25 are easily cleanable.

Cutter 25 is hingeably connected to the base 20 for operation as described herein. Base 15 has a floor 26, and has forward and rear ends 27 and 28. Base 15 includes a platform 30 with sides 32. Sides 32 include left side 34 and right side 36. Platform 30 has upper surface 38. Platform 30 has a forward end 40 and a rear end 42. Forward end 40 is spaced upwardly from an upper surface of floor 26 a distance 44. Platform 30 slants downwardly from the forward end 40 to the rear end 42 thereof. An opening 46 is defined in floor 26 near the rear end thereof. Opening 46 may be used to hang slicer 10 when not in use. A notch 48 extends rearwardly from forward end 40 to provide for an easy grasping of the cutter 25. A plurality of feet 50, which may be anti-slip rubber feet 50 are attached to floor 26 to provide stability when placed on a surface 52 for use. Feet 50 will contact surface 52 upon which the food slicer 10 is resting. An opening 54 which in the embodiment described is a generally oval shaped opening is defined in base 15. Opening 54 will allow slices of food to fall therethrough. Opening 54 has a pair of keyways 56 which in the embodiment shown are generally rectangular shaped keyways 56. Keyways 56 include a rear keyway 60 and a forward keyway 58. Keyways 58 and 60 are utilized to hold complementary food support structure 20 in place on the assembled food slicer 10.

A hinge 64 extends upwardly from platform 30. Hinge 64 provides a hingable connection with cutter 25. Hinge 64 includes an upstanding leg 66 and two upstanding legs 68 spaced rearward therefrom. A space 70 is defined between forward leg 66 and the two rear legs 68. Forward leg 66 may incline slightly rearward while rear legs 68 may incline slightly forward so that a hinge or pivot pin on cutter 25 may pass through space 70 and be pivotably held in place thereby. Base 15 further includes a plurality of primary food support members 72 extending upwardly from platform 30.

Primary food support members 72 comprise a forward primary food support member 78, an intermediate primary food support member 76 and a rear primary food support member 74. Forward primary support member 78 has a height 79, middle primary support member 76 has a height 77 and rear primary support member 74 has a height 75. As shown in the figures, the heights of the support members are descending from forward to rear, so that height 79 is greater than height 77 and height 77 is greater than height 75.

Rear primary food support member 74 has a pair of legs 80 extending upwardly from platform 30 and has a cradle 84 extending therebetween. Cradle 84 may be curved to provide a support for food to be placed thereon. Connection points 82 between legs 74 and platform 30 should be a minimum 0.125 inch corner radii. Primary intermediate support 76 has legs 86 extending upwardly from base 30 with connection points 88 with base 30 having a corner radius of a minimum of 0.125 inches. A cradle 90 which may be a curved cradle extends between legs 86.

Forward primary support 78 comprises a pair of legs 92 extending upwardly from platform 30. Legs 78 and base 30 have connection points 94 which have corner radii of a minimum of 0.125 inches. A cradle 96 extends between legs 92. Each of cradles 84, 90, and 96 may comprise curved cradles configured and shaped to support a food product such as a boiled egg thereon. Although as described there are three primary food supports 72 extending upwardly from platform 30, it is understood that more or less support may be utilized. Spaces 97 are defined between primary food supports 74, 76 and 78 and may include space 98 defined by and between primary food supports 74 and 76 and space 100 defined by and between primary food supports 76 and 78. Spaces 98 and 100 are in the embodiment shown substantially the same. Supports 74 and 76 have width 81 and depth 83. Width 81 may be wider than depth 83.

Food slicer 10 includes complementary food support structure 20. Complementary food support structure 20 comprises a support ring 110 which in the embodiment described is a generally oval shaped support ring. Support ring 110 has a plurality of complementary food support members 112 extending upwardly therefrom. Each of complementary food support members 112 has connection points 114 with support ring 110. The corner radii at connection points 114 are minimum 0.125 inch corner radii. Complementary support members 112 include forward complementary support 118, first intermediate complementary support member 120, second intermediate complementary support member 122 and rear complementary support member 124. Complementary support members 118, 120, 122, and 124 may also be referred to as first, second, third and fourth complementary support members.

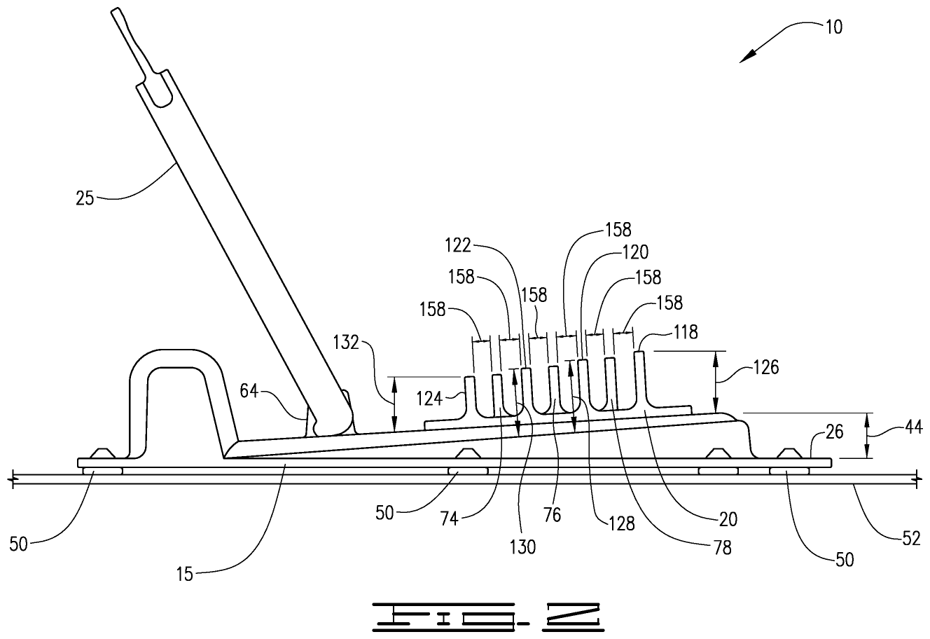

Complementary support members 118, 120, 122, and 124 have heights 126, 128, 130 and 132 respectively. The complementary support members are configured to be descending in height from forward to rear such that height 126 is greater than height 128, which is greater than height 130 which is greater than height 132. As shown in FIG. 2 and other FIGS. primary food supports 72 and complementary food supports 112 are descending in height from the forward end 40 to the rear end 42 of platform 30.

Complementary support members 112 have spaces 133 therebetween. Spaces 133 include space 134 between complementary support members 118 and 120, space 136 between complementary support members 120 and 122, space 138 between complementary members 122 and 124. Spaces 134, 136, and 138 are in the embodiment shown substantially the same width and are substantially the same as spaces 98 and 100. In one embodiment the spaces are between about 0.40 and 0.60 inches, and may be about 0.50 inches.

Complementary support member 118 comprises legs 142 extending upwardly from support ring 110. A cradle 144 which may be a curved cradle is connected to and extends between legs 142. Complementary support member 120 comprises a pair of legs 146 extending upwardly from support ring 110 and a curved cradle 148 extending therebetween. Complementary support member 122 comprises legs 150 extending upwardly from support ring 110 with cradle 152 extending therebetween. Cradle 152 is a curved cradle. Complementary support member 124 comprises a pair of legs 154 extending upwardly from support ring 110 and a curved cradle 156 extending therebetween. Complementary food support 20 has tabs 157 extending from the forward and rear ends thereof. Tabs 157 are received in keyways 58 and 60 and will fit beneath platform 30 to removably attach complementary food support 20 to base 15. When the complementary food support 20 is attached to base 15, spaces 158 are defined by and between primary food supports 72 and complementary food supports 112. Spaces 158 are in the embodiment described equal spaces, and are one-half the width of spaces 133 and 97.

Cutter 25 has an outer ring 160 with an upper edge 159 and a lower edge 161. Outer ring 160 in the embodiment shown is a generally oval shaped outer ring. A rim 162 extends radially inwardly from the outer ring 160. Outer ring 160 may be referred to as a cutter frame 160. A plurality of cutter blades 164 span the distance across the outer ring 160. Cutter blades have first end 166 and second end 168 connected to rim 162. The cutter blades 164 will be identified with the subscripts a-h simply for ease of identification. Cutter blades 164 are connected at the first and second ends 166 and 168 thereof at connection points 170 each of which has a radius of no less than 0.125 inches. The connection points 176 at the sides 174 of each of the cutter blades 164 likewise have a radius of no less than 0.125 inches.

Cutter blades 164 have top edge 178, which is generally a flat top edge with a width 179. Cutter blades 164 taper inwardly from the top edge 178 to a bottom edge 180 which is a sharp cutting edge 180. Cutter blades 164 have spaces 182 therebetween which in the embodiment described are equal spaces 182. Spaces 182 are substantially the same width as spaces 158.

A pair of arms 190 which may be a first arm 192 and a second arm 194 extend rearwardly from outer ring 160. Arms 192 and 194 have connection points 196 to outer ring 160. Connection points 196 have a radius of no less than 0.125 inches. A hinge pin 200 extends between and is connected to arms 192 and 194. A tab 202 extends forward from the forward end of outer ring 160 and may be used to rotate cutter 25 between open and closed positions to slice food product, such as a boiled egg that has been placed on primary and complementary food supports.

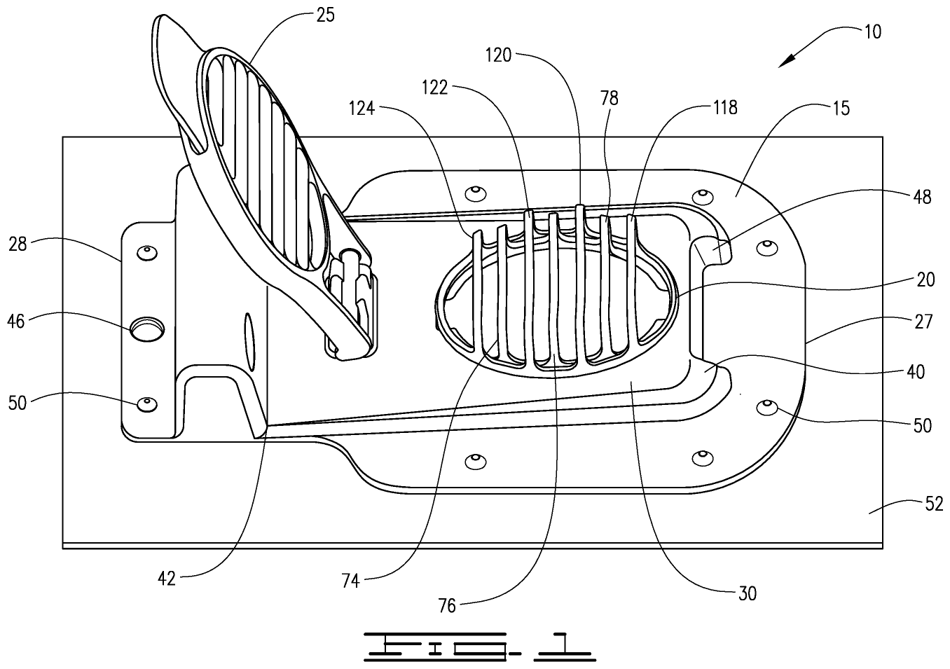

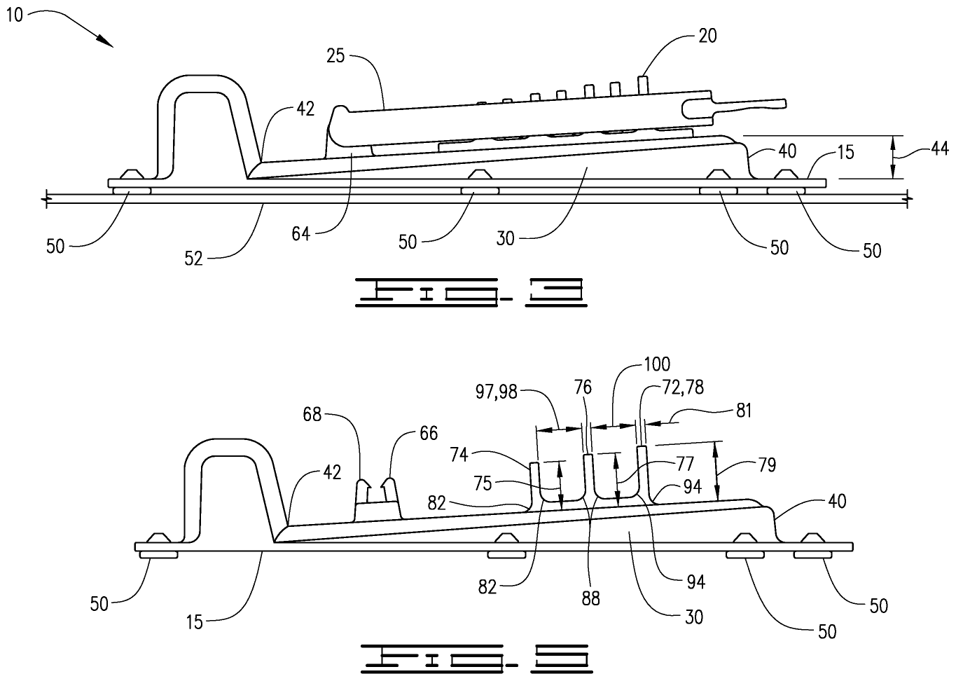

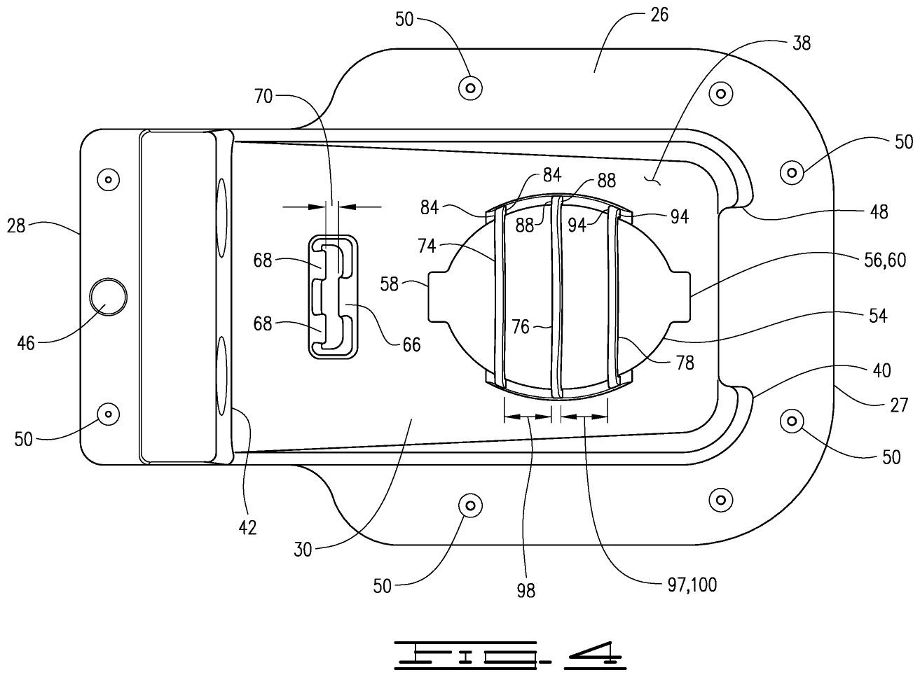

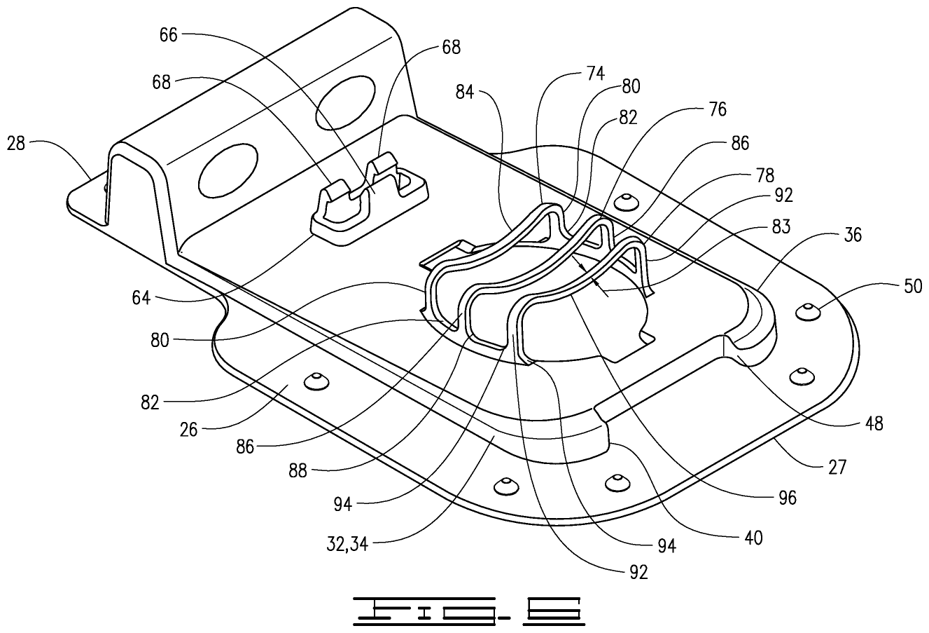

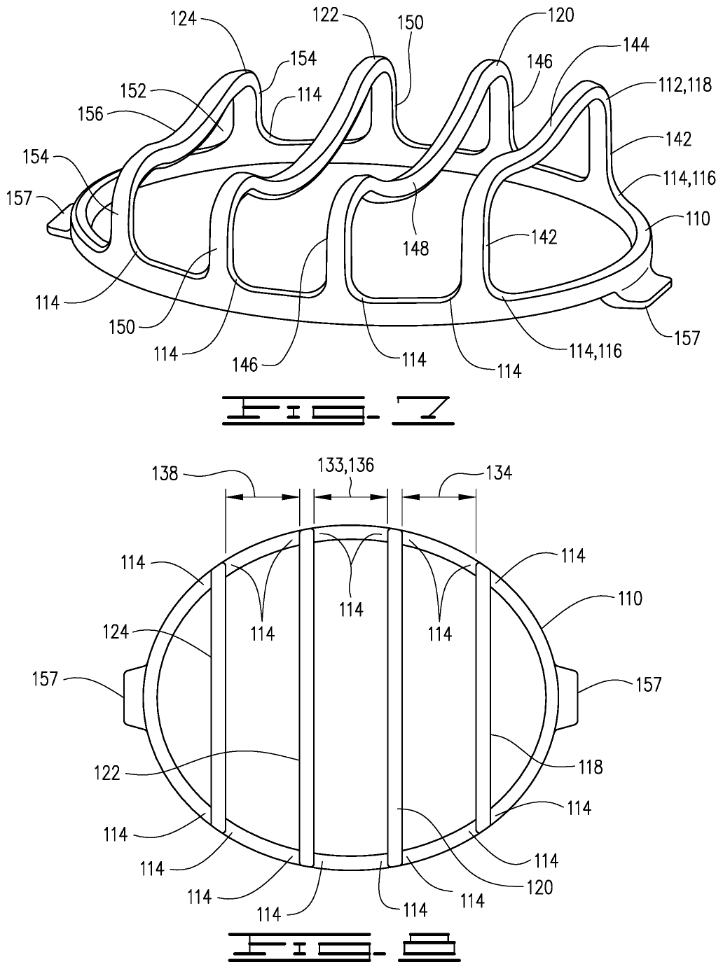

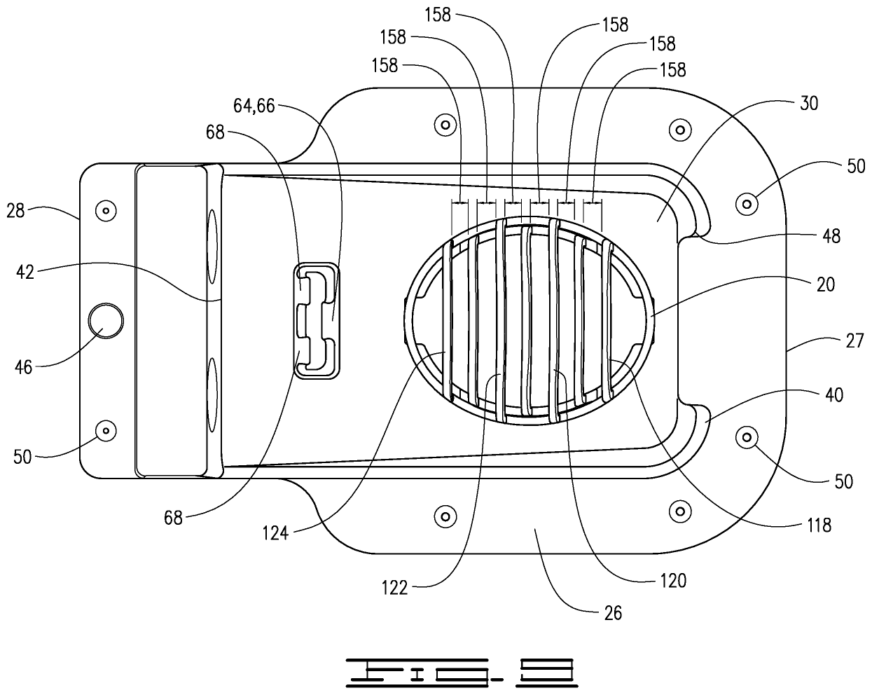

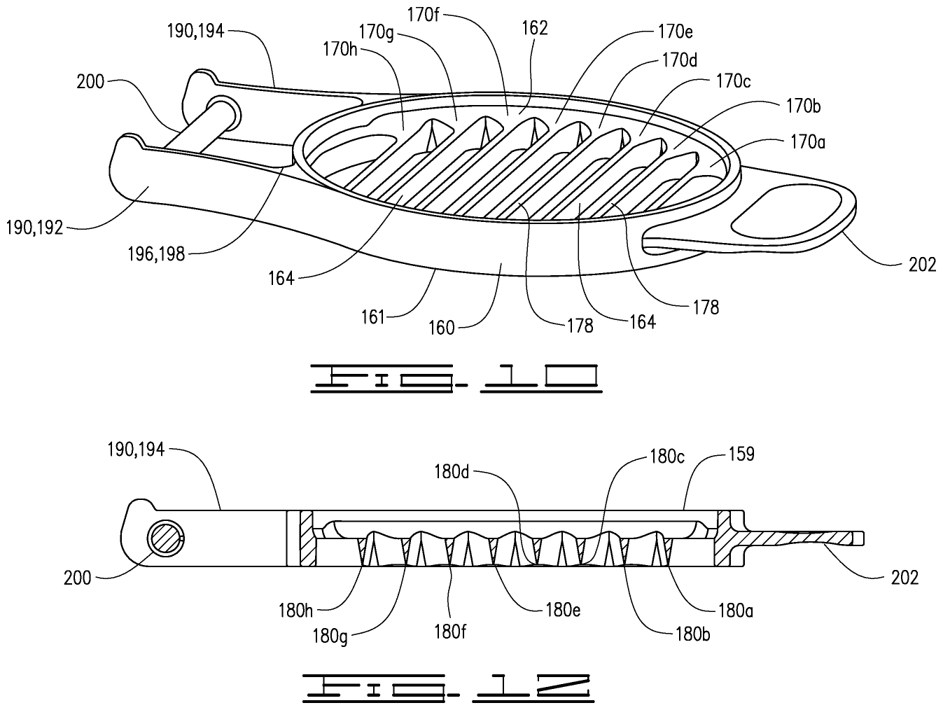

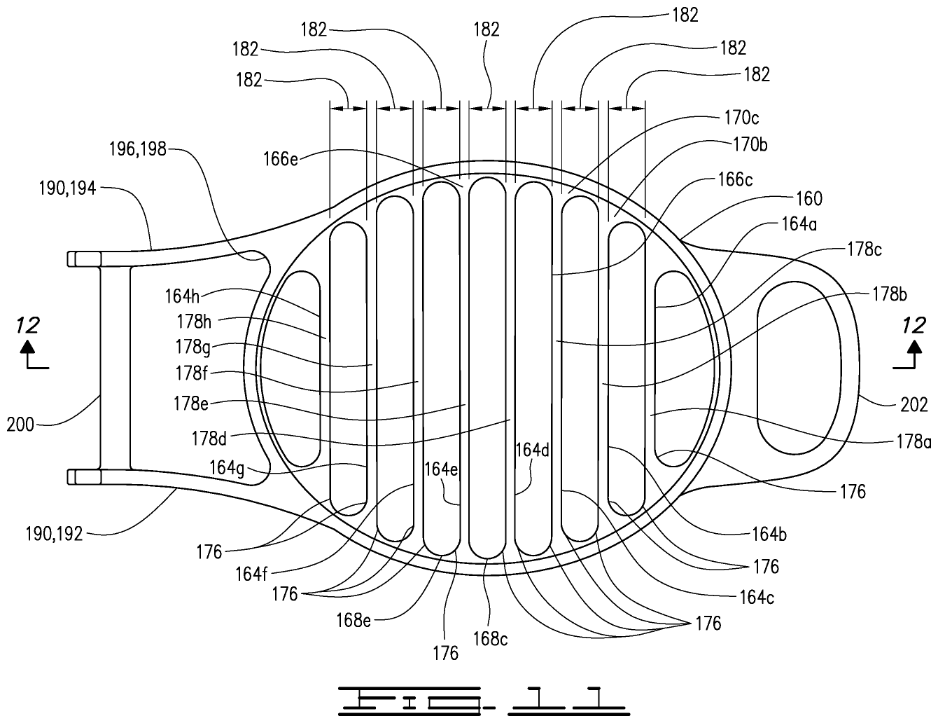

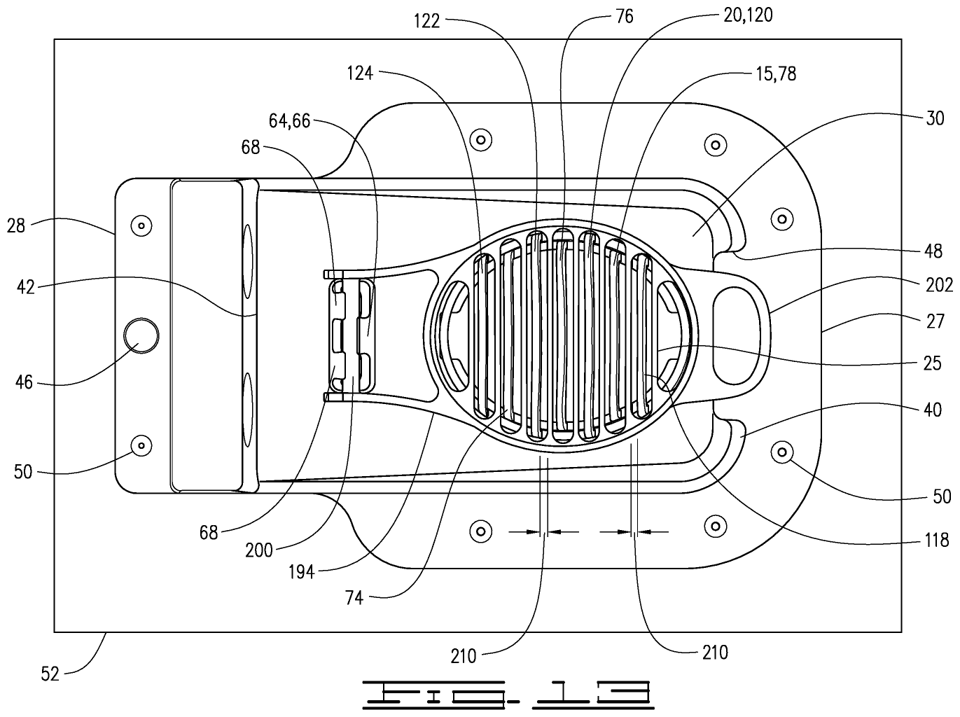

The operation of the food slicer 10 is apparent from the drawings. The food slicer is movable from an open position shown in FIGS. 1 and 2 to the closed position shown in FIG. 3. When moved from the open to the closed position cutting blades 164 will engage a food product, for example a boiled egg, placed upon primary food support members 72 and complementary support members 112. Cutter blades 164 will pass through spaces 158 and in one embodiment will bisect spaces 158 into equal width spaces 210. As a result the food product placed thereon will be sliced into equal thickness slices.

The food slicer 10 disclosed herein is easily cleanable and is configured to be NSF rated. As a result, a food slicer built in accordance with this disclosure is NSF rated. Food slicer 10 is non-destructively disassemblable, and may be separated into component parts of base 15, complementary food support 20 and cutter 25, each of which is easily cleanable. The corner radii noted herein at the intersection of two planes which are in an area of potential food contact, are to be a minimum of 0.125 inches. The result is a food slicer that it easily operable, easily cleanable and may be NSF rated.

Thus it is seen that the apparatus and methods of the present invention readily achieve the ends and advantages mentioned as well as those inherent therein. While certain preferred embodiments of the invention have been illustrated and described for purposes of the present disclosure, numerous changes in the arrangement and construction of parts and steps may be made by those skilled in the art, which changes are encompassed within the scope and spirit of the present invention.

What is claimed is:

1. A food slicer comprising:
a base;
a plurality of spaced apart primary food support members extending upwardly from the base;
a complementary food support removably connected to the base, the complementary food support comprising a plurality of spaced apart complementary food support members, the primary and complementary food support members defining a plurality of substantially equal width cutting spaces therebetween; and
a cutter comprising a plurality of spaced apart cutter blades configured to pass through the cutting spaces and a food product supported on the primary and complementary food support members and cut the food product into substantially equal thickness slices.

2. The food slicer of claim 1, wherein the cutter is non-destructively removably and replaceably connected to the base.

3. The food slicer of claim 2, the cutter being pivotably connected to the base.

4. The food slicer of claim 1 the cutter comprising a cutter frame with the plurality of cutter blades fixed to the cutter frame.

5. The food slicer of claim 4 wherein the minimum corner radii at the connection between the cutter frame and the cutter blades is at least about 0.125 inches.

6. The food slicer of claim 1, the complementary food support comprising a support ring and the plurality of complementary food support members connected thereto, the minimum corner radii at the connection between the support ring and the complementary food support members being 0.125 inches.

7. The food slicer of claim 1 wherein the complementary food support members are spaced apart at least about 0.50 inches.

8. The food slicer of claim 1, wherein the minimum corner radii at a connection point between the primary food supports and the base is at least about 0.125 inches.

9. A three piece food slicer comprising:
a base with a plurality of spaced apart primary food support members extending therefrom and having a first space therebetween;
a food support structure with a plurality of spaced apart complementary food support members removably connected to the base, the complementary food support members being parallel to the primary food support members and having a second space therebetween, the first and second spaces being substantially the same; and
a plurality of spaced apart cutter blades configured to pass through a food product placed upon the primary and complementary food support members and through third spaces defined by and between the primary and complementary food support members.

10. The food slicer of claim 9, the third spaces being approximately one-half the width of the first and second spaces.

11. The food slicer of claim 9, the spaced apart cutter blades being fixed to a cutter frame that is pivotably and removably attached to the base.

12. The food slicer of claim 11, wherein the cutter frame is detachably reconnectable to the base.

13. The food slicer of claim 12, wherein the food support structure is detachably reconnectable to the base.

14. The food slicer of claim 9, wherein a width of the spaces between the primary food support members is 0.50 inches and a width of the spaces between the complementary food support members is 0.50 inches.

15. A food slicer comprising:
a base;
a plurality of primary food support members extending upwardly from the base;
a plurality of complementary food support members spaced from the primary support members, the primary and complementary food support members defining a plurality of substantially equal width cutting spaces therebetween; and
a cutter connected to the base, the cutter comprising a plurality of cutter blades configured to pass through the cutting spaces and a food product supported on the primary and complementary food support members and cut the food product into substantially equal thickness slices.

16. The food slicer of claim 15 comprising a complementary food support structure removably connected to the base, the complementary food support structure comprising a support ring with the complementary food support members connected thereto.

17. The food slicer of claim 16, each of the base, complementary food support structure and cutter being easily cleanable.

18. The food slicer of claim 15, the cutter being detachably reconnectable to the base.

19. The food slicer of claim 18, the cutter being pivotably connected to the base.

20. The food slicer of claim 19, the primary food support members each comprising a curved cradle and the complementary food members each comprising a curved cradle.
